(19) United States
(12) Patent Application Publication
(10) Pub. No.: US 2022/0399708 A1
(43) Pub. Date: Dec. 15, 2022

(54) APPARATUS AND METHOD FOR DIAGONAL GROUNDING

(71) Applicant: SUNGJIN INC, Cheongju-si, Chungcheongbuk-do (KR)

(72) Inventor: Jeong-Yeon SEO, Cheongju-si (KR)

(73) Assignee: SUNGJIN INC, Cheongju-si, Chungcheongbuk-do (KR)

(21) Appl. No.: 17/775,642

(22) PCT Filed: Nov. 10, 2020
(86) PCT No.: PCT/KR2020/015664

§ 371 Date: May 10, 2022

(30) Foreign Application Priority Data
Nov. 12, 2019 (KR) 10-2019-0143974

(51) Int. Cl. H02G 13/00; H01R 4/66

(52) U.S. Cl. CPC H02G 13/40; H01R 4/66

(57) ABSTRACT

Electrical equipment is grounded in order to suppress ground potential rise in a healthy phase due to a failure of a line in a distribution line, to reduce abnormal voltages or prevent the occurrence of abnormal voltages caused by lightning surges, etc., to operate a protective relay when a ground fault occurs, or the like. Grounding is installed by burying a grounding electrode such as a copper rod in the ground and connecting the electrical equipment to be protected with a grounding line, and at this time, a reference value of grounding resistance varies according to the equipment. When grounding electrical equipment such as lightning arresters and transformers, it is necessary to lower a grounding resistance value, but a problem occurs when installing grounding by digging a pit in an urban area to erect an electric pole in that it is difficult to lower the grounding resistance value since it is difficult to install grounding in parallel because roads are paved. Accordingly, the objective of the present invention is to provide an apparatus and a method capable of lowering the grounding resistance value by digging a pit to erect an electric pole, and burying a grounding rod by means of hitting on a side of the pit diagonally in various directions, and installing grounding in series or parallel.

### TECHNICAL FIELD

The present invention relates to a device and construction method used for installation of grounding in electric pole construction of a distribution line.

### BACKGROUND ART

In the distribution line, electrical equipment is grounded to suppress earth potential rise at electrical substations due to a failure or breakdown of the line, reduce abnormal voltage due to lightning surge, prevent occurrence of the abnormal voltage, or operate a protective relay in the case of ground fault.

Grounding (or earthing) is installed by burying a grounding electrode such as a copper bar in the ground and connecting the electrical equipment to be protected with an earth wire, wherein a reference value of the grounding resistance (“earth resistance”) varies depending on facilities.

When grounding the electrical equipment such as lightning arresters, transformers, etc., an earth resistance value needs to be lower. However, in the case of an urban area, when digging a pit and erecting a pole to install the grounding, it is difficult to install the grounding in parallel due to paved roads, hence causing a problem of difficulties in lowering the earth resistance value.

### DISCLOSURE

### Technical Problem

In order to solve the problem in the grounding installation for construction of an electric pole used for urban distribution line,

the present invention is intended to provide a device and construction method capable of lowering an earth resistance value, which includes digging a pit, erecting an electric pole in the pit, and burying an earth rod on a lateral side of the pit diagonally in different directions to install the grounding in series or parallel, thereby decreasing the earth resistance value.

### Technical Solution

in order to solve the above problems, the present invention provides a diagonal grounding device, including:

a lead terminal connector 16 in the form of a circular iron bar, which has a concave portion (“recess”) on one side to be coupled with a lead terminal 5 while having the other side to be coupled with a recess of an iron bar 11 on one side thereof, followed by being secured with a fixing bolt 17;

the iron bar 11 in a circular form, which has a recess on one side to be coupled with the lead terminal connector 16 while having another recess on the other side to be coupled with one side of a sliding rail 12;

the sliding rail 12 in the form of a circular iron bar, which is coupled at one side with the recess on the other side of the iron bar 11 while being provided with a circular cap 14 on the other side of the rail to be secured with a fixing pin 15, wherein a circumferential surface (or a peripheral surface) is coupled with an inner hole of a hammer 13; and

the hammer 13 in the form of I-shaped dumbbell, which is provided with weights on both sides and a hole in a center axis to be coupled with the peripheral surface of the sliding rail 12.

A construction method using the diagonal grounding device of the present invention may include:

firstly digging a pit for electric pole (“electric pole pit”) 1 in the ground and erecting an electric pole 2 having an earth wire 3 inserted therein in the pit;

a preparation step for installation of the grounding, which includes checking a copper bar 4 and a lead terminal 5, releasing a fixing bolt 17 from a sliding hammer 10, and separating a lead terminal connector 16 (S100);

a primarily hitting and burying step of the copper bar, which includes inserting the other side of the copper bar 4 into a recess on one side of an iron bar 11 in the sliding hammer 10, putting one side of the copper bar 4 diagonally on a lateral side of the pit 1, hitting the hammer 13 while moving up and down the hammer 13 to the sliding rail 12 to bury the copper bar in the lateral side of the pit 1 such that the other side of the copper bar 4 is located at the ground level, and separating the sliding hammer 10 (S200);

an earth wire connection step, which includes connecting a lead wire of the lead terminal 5 and the earth wire 3 (S300);

a secondary hitting and burying step of the earth rod, which includes coupling the lead terminal connector 16 in the recess on one side of the iron bar 11 of the sliding hammer 10 and then securing the same with a fixing bolt 17, arranging the recess of the lead terminal connector 16, the lead terminal 5 and the recess on the other side of the iron bar 11 in a linear line, hitting the same with the hammer 13 to couple the lead terminal 5 with the copper bar 4, and burying the earth rod 6 deeper in the lateral side of the pit (S400); and

a withdrawal step of the sliding hammer 10, which includes burying the earth rod 6 deeper in the lateral side of the pit, followed by separating and withdrawing the sliding hammer 10 from the earth rod 6 (S500).

### Advantageous Effects

As described above, the diagonal grounding device and construction method thereof according to the present invention includes,

hitting and burying the earth rod 6 diagonally in a lateral side of the electric pole pit 1 by the sliding hammer 10, so that the grounding can be installed in series or parallel within the pit to thus attain effects of lowering an earth resistance value.

### DESCRIPTION OF DRAWINGS

FIG. 1 illustrates a configuration of the sliding hammer according to an embodiment of the present invention.

FIG. 2 illustrates primary hitting and burying using the sliding hammer according to an embodiment of the present invention.

FIG. 3 illustrates connection of the earth wire according to an embodiment of the present invention.

FIG. 4 illustrates secondary hitting and burying using the sliding hammer according to an embodiment of the present invention.

FIG. 5 a plan view illustrating four (4)-parallel groundings according to an embodiment of the present invention.

FIG. 6 illustrates steps of the diagonal grounding construction method according to an embodiment of the present invention.

### DESCRIPTION OF REFERENCE NUMERALS

1: Pit 2: Electric pole
3: Earth wire 4: Copper bar
5: Lead terminal 6: Earth rod (4+5)
10: Sliding hammer (11 to 17)
11: Iron bar 12: Sliding rail
13: Hammer 14: Circular cap
15: Fixing pin 16: Lead terminal connector
17: Fixing bolt

### BEST MODE

The diagonal grounding device and construction method thereof according to the present invention will be described in detail by means of the following embodiments.

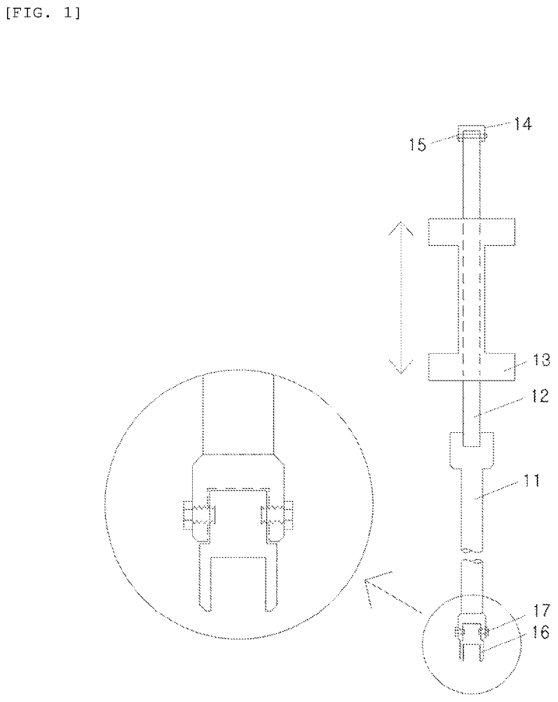

First, referring to FIG. 1, the configuration of a sliding hammer as a diagonal grounding device will be described as follows, that is, the device may include:

a lead terminal connector 16 in the form of a circular iron bar, which has a concave portion (“recess”) on one side to be coupled with a lead terminal 5 while having the other side to be coupled with a recess of an iron bar 11 on one side thereof, followed by being secured with a fixing bolt 17;

the iron bar 11 in a circular form, which has a recess on one side to be coupled with the lead terminal connector 16 while having another recess on the other side to be coupled with one side of a sliding rail 12;

the sliding rail 12 in the form of a circular iron bar, which is coupled at one side with the recess on the other side of the iron bar 11 while being provided with a circular cap 14 on the other side of the rail to be secured with a fixing pin 15, wherein a peripheral surface is coupled with an inner hole of a hammer 13; and

the hammer 13 in the form of I-shaped dumbbell, which is provided with weights on both sides and a hole in a center axis to be coupled with the peripheral surface of the sliding rail 12.

The sliding hammer 10 may hit the weight hammer 13 in a linear line with an earth rod 6 along the sliding rail 12 so as to effectively bury the earth rod 6 and further bury the earth rod 6 deeper along a length of the iron bar 11.

Further, since an outer diameter of the lead terminal 5 is different from an outer diameter of the recess at the other side of the copper bar 4 in terms of a size, the recess of the lead terminal connector 16 may be coupled with the lead terminal 5 while the recess at one side of the iron bar 11 may be coupled with the other side of the copper bar 4.

Next, a construction method using the diagonal grounding device according to the present invention will be described.

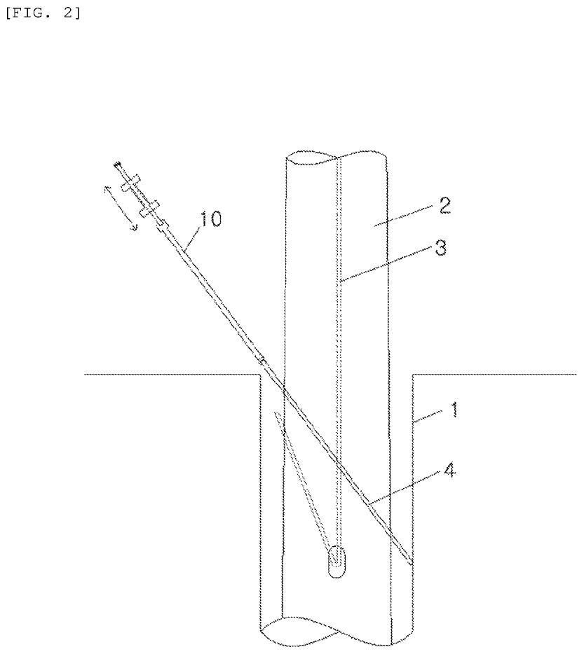

FIG. 2 illustrates primary hitting and burying using the sliding hammer according to an embodiment of the present invention.

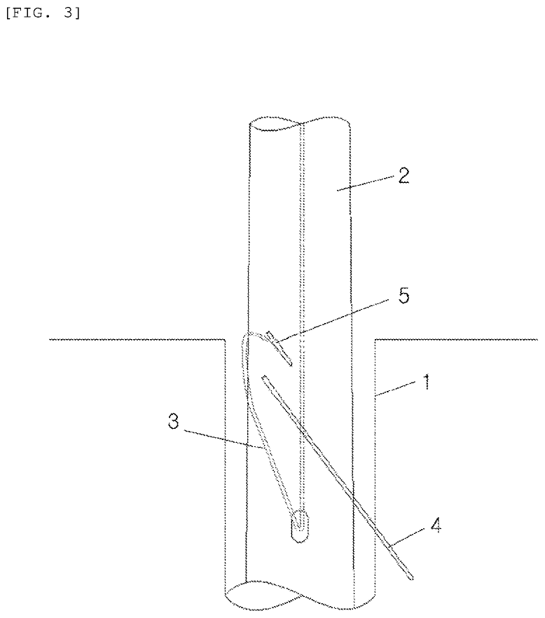

FIG. 3 illustrates connection of the earth wire according to an embodiment of the present invention.

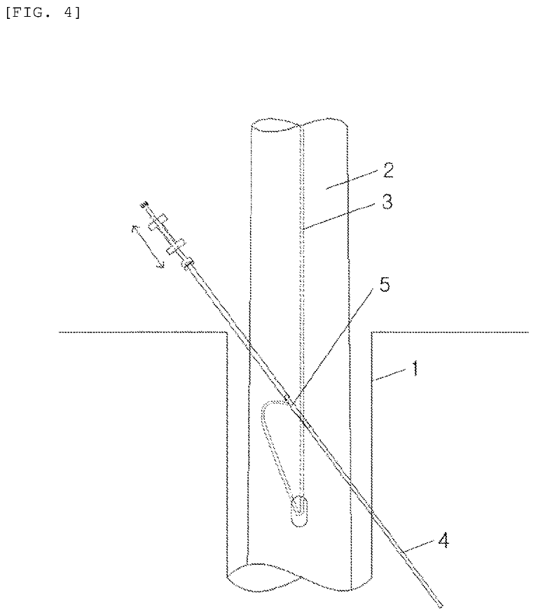

FIG. 4 illustrates secondary hitting and burying using the sliding hammer according to an embodiment of the present invention.

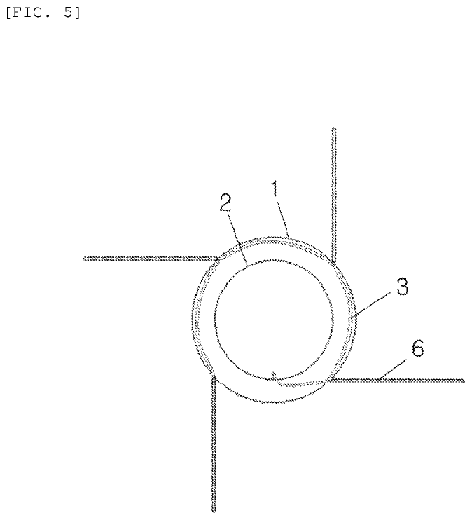

FIG. 5 is a plan view illustrating four (4)-parallel groundings according to an embodiment of the present invention.

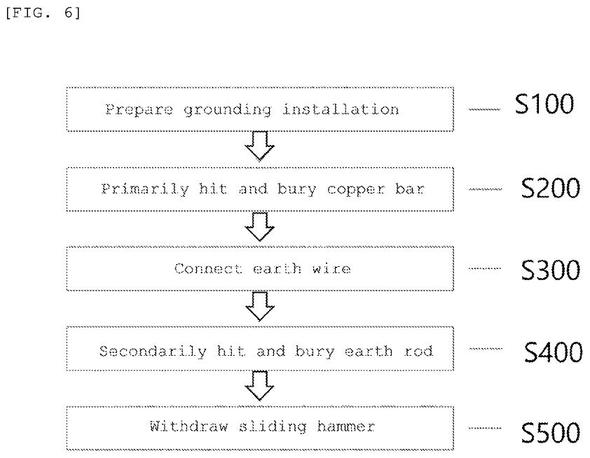

FIG. 6 illustrates steps of the diagonal grounding construction method according to an embodiment of the present invention.

The diagonal grounding construction method in FIG. 2 may be described with reference to FIG. 6. Specifically, the construction method may include:

beforehand, after digging an electric pole pit 1 in the ground and erecting an electric pole 2, in which an earth wire 3 is inserted, in the pit,

a preparation step for installation of the grounding, which includes checking a copper bar 4 and a lead terminal 5, releasing a fixing bolt 17 from a sliding hammer 10, and separating a lead terminal connector 16 (S100);

a primary hitting and burying step of the copper bar, which includes inserting the other side of the copper bar into a recess on one side of an iron bar 11 in the sliding hammer 10, putting one side of the copper bar 4 diagonally on a lateral side of the pit 1, hitting the hammer 13 while moving up and down the hammer 13 to the sliding rail 12 to bury the copper bar 4 in the lateral side of the pit 1 such that the other side of the copper bar 4 is located at the ground level, and separating the sliding hammer 10 (S200);

an earth wire connection step, which includes connecting a lead wire of the lead terminal 5 and the earth wire 3 (S300);

a secondary hitting and burying step of the earth rod, which includes coupling the lead terminal connector 16 in the recess on one side of the iron bar 11 of the sliding hammer 10 and then securing the same with a fixing bolt 17, arranging the recess of the lead terminal connector 16, the lead terminal 5 and the recess on the other side of the iron bar 11 in a linear line, hitting the same with the hammer 13 to couple the lead terminal 5 with the copper bar 4, and burying the earth rod 6 deeper in the lateral side of the pit (S400); and

a withdrawal step of the sliding hammer 10, which includes burying the earth rod 6 deeper in the lateral side of the pit, followed by separating and withdrawing the sliding hammer 10 from the earth rod 6 (S500).

As shown in FIG. 4, the groundings may be installed in parallel in various directions, thereby decreasing an earth resistance value.

If a distance between tops of the earth rods 6 constructed in parallel is insufficient, grounding effects may be reduced. In this case, when the earth resistance value exceeds the standard, the copper bars may be further extended in series to reinforce the grounding.

If the ground is solid and it is difficult to bury the earth rod 6 only by hitting using the hammer 13, the earth rod may be buried by hitting a circular cap 14 of the sliding hammer 10 by means of an electric hammer, an excavator, or the like.

As described above, the diagonal grounding device and construction method according to the present invention may utilize the sliding hammer 10 to bury the earth rod 6 on a lateral side of the pit 1 diagonally in various directions, whereby groundings can be installed in series or parallel within the pit 1, in order to erect an electric pole even in an urban area where has difficulties in excavating for grounding installation, thereby accomplishing effects of reducing the earth resistance value.

### INDUSTRIAL APPLICABILITY

The present invention relates to a device and a construction method used for erecting an electric pole and installing grounding equipment in a distribution line.

Specifically, when performing electric pole construction in an urban area, the groundings may be installed in series or parallel by burying the earth rods on a lateral side of the electric pole pit diagonally in various directions in a place where low earth resistance value is required, such as a lightning arrester, a transformer, etc., so as to reduce an earth resistance value. Therefore, it is expected that the present invention can be widely used in construction sites of electric poles.

1. A diagonal grounding device used for installation of a grounding in electric pole construction of a distribution line, comprising:
a lead terminal connector (16) in a form of a circular iron bar, which has a concave portion (“recess”) on one side to be coupled with a lead terminal (5) while having another side to be coupled with a recess of an iron bar (11) on one side thereof, followed by being secured with a fixing bolt (17);
the iron bar (11) in a circular form, which has a recess on one side to be coupled with the lead terminal connector (16) while having another recess on another side to be coupled with one side of a sliding rail (12);
the sliding rail (12) in the form of a circular iron bar, which is coupled at one side with the recess on the other side of the iron bar (11) while being provided with a circular cap (14) on the other side of the rail to be secured with a fixing pin (15), wherein a peripheral surface thereof is coupled with an inner hole of a hammer (13); and
the hammer (13) in the form of I-shaped dumbbell, which is provided with weights on opposite sides and a hole in a center axis to be coupled with the peripheral surface of the sliding rail (12).

2. A construction method used for installation of grounding in electric pole construction of a distribution line, comprising:
a preparation step for installation of the grounding, which includes checking a copper bar (4) and a lead terminal (5), releasing a fixing bolt (17) from a sliding hammer (10), and separating a lead terminal connector (16) (S100);
a primary hitting and burying step of the copper bar, which includes inserting the other side of the copper bar (4) into a recess on one side of an iron bar (11) in the sliding hammer (10), putting one side of the copper bar (4) diagonally on a lateral side of the pit (1), hitting the hammer (13) while moving up and down the hammer (13) to the sliding rail (12) to bury the copper bar (4) in the lateral side of the pit (1) such that the other side of the copper bar (4) is located at the ground level, and separating the sliding hammer (10) (S200);
an earth wire connection step, which includes connecting a lead wire of the lead terminal (5) and the earth wire (3) (S300);
a secondary hitting and burying step of the earth rod, which includes coupling the lead terminal connector (16) in the recess on one side of the iron bar (11) of the sliding hammer (10) and then securing the same with a fixing bolt (17), arranging the recess of the lead terminal connector (16), the lead terminal (5) and the recess on the other side of the iron bar (11) in a linear line, hitting the same with the hammer (13) to couple the lead terminal (5) with the copper bar (4), and burying the earth rod (6) deeper in the lateral side of the pit (S400); and
a withdrawal step of the sliding hammer (10), which includes burying the earth rod (6) deeper in the lateral side of the pit, followed by separating and withdrawing the sliding hammer (10) from the earth rod (6) (S500)
